(19) United States
(12) Patent Application Publication
(10) Pub. No.: US 2024/0381340 A1
(43) Pub. Date: Nov. 14, 2024

(54) METHOD AND DEVICE FOR RECEIVING AND TRANSMITTING INFORMATION

(71) Applicant: SAMSUNG ELECTRONICS CO., LTD., Suwon-si (KR)

(72) Inventors: Jingxing FU, Beijing (CN); Feifei SUN, Beijing (CN); Zhe CHEN, Beijing (CN)

(21) Appl. No.: 18/658,883

(22) Filed: May 8, 2024

(30) Foreign Application Priority Data
May 10, 2023 (CN) 202310524602.6

(51) Int. Cl. H04W 72/1263

(52) U.S. Cl. CPC H04W 72/1263

(57) ABSTRACT

The disclosure relates to a 5G or 6G communication system for supporting a higher data transmission rate. The present disclosure provides a method performed by a UE and a base station in a wireless communication network, the method performed by the UE including: receiving first information for scheduling a first frequency domain resource including a plurality of second frequency domain resources; upon the second information is received, determining, based on the first information and the second information and from the plurality of second frequency domain resources, a second frequency domain resource for downlink transmission or uplink transmission scheduled by the first information, and the second information including indication information indicating that each second frequency domain resource in the plurality of second frequency domain resources is a downlink frequency domain resource or an uplink frequency domain resource; performing downlink transmission or uplink transmission on the determined second frequency domain resource.

### CROSS-REFERENCE TO RELATED APPLICATION

This application is based on and claims priority under 35 U.S.C. § 119 (a) of a Chinese patent application number 202310524602.6, filed on May 10, 2023, in the Chinese Patent Office, the disclosure of each of which is incorporated by reference herein in its entirety.

### BACKGROUND

### 1. Field

The present application relates to the field of wireless communication technologies, and in particular, to a method and a device for receiving and transmitting data and control information.

### 2. Description of Related Art

5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mm Wave) including 28 GHz and 39 GHz. In addition, it has been considered to implement 6th generation (6G) mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio-unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there is ongoing standardization in air interface architecture/protocol regarding technologies, such as industrial Internet of things (IIoT), for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

According to an aspect of the present disclosure, a method performed by a user equipment (UE) in a wireless communication network, including: receiving first information for scheduling a first frequency domain resource including a plurality of second frequency domain resources; upon receiving second information, determining, based on the first information and the second information and from the plurality of second frequency domain resources, a second frequency domain resource for downlink transmission or uplink transmission scheduled by the first information, and the second information including indication information indicating that each second frequency domain resource in the plurality of second frequency domain resources is a downlink frequency domain resource or an uplink frequency domain resource; and performing downlink transmission or uplink transmission on the determined second frequency domain resource.

In an example, when the first information schedules downlink transmission, the downlink frequency domain resource indicated by the second information in the plurality of second frequency domain resources is used for the downlink transmission; or when the first information schedules uplink transmission, the uplink frequency domain resource indicated by the second information in the plurality of second frequency domain resources is used for the uplink transmission.

In an example, when the first information schedules downlink transmission and a ratio of the downlink frequency domain resource indicated by the second information in the plurality of second frequency domain resources is greater than or equal to a first threshold, the downlink frequency domain resource indicated by the second information in the plurality of second frequency domain resources is used for the downlink transmission; or when the first information schedules uplink transmission, and a ratio of the uplink frequency domain resource indicated by the second information in the plurality of second frequency domain resources is greater than or equal to a second threshold, the uplink frequency domain resource indicated by the second information in the plurality of second frequency domain resources is used for the uplink transmission.

In an example, when the first information schedules downlink transmission and the ratio of the downlink frequency domain resource indicated by the second information in the plurality of second frequency domain resources is less than the first threshold, the downlink transmission is not performed; or when the first information schedules uplink transmission and the ratio of the uplink frequency domain resource indicated by the second information in the plurality of second frequency domain resources is less than the second threshold, the uplink transmission is not performed.

In an example, the method further includes: when the second information is not received, performing downlink transmission or uplink transmission on the plurality of second frequency domain resources scheduled by the first information.

In an example, the method further includes: when the second information is received, performing downlink transmission or uplink transmission on the plurality of second frequency domain resources scheduled by the first information.

In an example, the first information is via dynamic scheduling, semi-persistent scheduling, or configured grant (CG); and/or the second information is dynamic information or semi-static information.

In an example, the first frequency domain resource is a resource block group (RBG), and the plurality of second frequency domain resources includes physical resource blocks (PRBs) or resource blocks (RBs).

According to an aspect of the present disclosure, a method performed by a user equipment (UE) in a wireless communication network includes: receiving a first message including first information and second information, the first information used to schedule a first frequency domain resource including a plurality of second frequency domain resources, and the second information including indication information indicating that each second frequency domain resource in the plurality of second frequency domain resources being a downlink frequency domain resource or an uplink frequency domain resource; determining, based on the first information and the second information and from the plurality of second frequency domain resources, a second frequency domain resource for downlink transmission or uplink transmission scheduled by the first information; and performing downlink transmission or uplink transmission on the determined second frequency domain resource.

In an example, the first message is received via downlink control information (DCI).

According to an aspect of the present disclosure, a method performed by a base station in a wireless communication network includes: transmitting first information for scheduling a first frequency domain resource including a plurality of second frequency domain resources; performing downlink transmission or uplink transmission on at least one second frequency domain resource in the plurality of second frequency domain resources, wherein, when the second information is transmitted, the at least one second frequency domain resource is determined based on the first information and the second information, and the second information includes indication information indicating that each of the plurality of second frequency domain resources is a downlink frequency domain resource or an uplink frequency domain resource.

In an example, the first information is via dynamic scheduling, semi-persistent scheduling, or configured grant CG; and/or the second information is dynamic information or semi-static information.

In an example, the first frequency domain resource is a resource block group (RBG), and the plurality of second frequency domain resources include physical resource blocks (PRBs) or resource block (RBs).

According to an aspect of the present disclosure, a method performed by a base station in a wireless communication network includes: transmitting a first message including first information and second information, the first information used to schedule a first frequency domain resource including a plurality of second frequency domain resources, and the second information including indication information indicating that each second frequency domain resource in the plurality of second frequency domain resources being downlink frequency domain resource or uplink frequency domain resource; performing downlink transmission or uplink transmission on at least one second frequency domain resource in the plurality of second frequency domain resources, wherein, at least one second frequency domain resource is determined based on the first information and the second information.

In an example, the first message is transmitted via downlink control information (DCI).

According to an aspect of the present disclosure, a user equipment in a wireless communication network is provided, the user equipment including a transceiver and a controller coupled to the transceiver, where the controller is configured to perform the method disclosed in the present application that can be performed by the user equipment.

According to an aspect of the present disclosure, a base station in a wireless communication network is provided, the base station including a transceiver and a controller coupled to the transceiver, where the controller is configured to perform the method disclosed in the present application that can be performed by the base station.

By using the method and device provided in the present application, it can be better ensured that the user equipment (UE) and the base station have the same understanding of the allocated resources, and that the resources can be fully utilized as much as possible under the premise of ensuring that the understanding of the allocated resources is the same.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

The above and additional aspects and advantages of the present application are clearer and easier to understand from the following description made with reference to the drawings, in which:

FIG. 1 illustrates an example of a wireless network in accordance with various embodiments of the present disclosure;

FIGS. 2A and 2B illustrate examples of wireless transmit and receive paths in accordance with various embodiments of the present disclosure;

FIG. 3A illustrates an example of a user equipment in accordance with various embodiments of the present disclosure;

FIG. 3B illustrates an example of a base station in accordance with various embodiments of the present disclosure;

FIG. 4 illustrates an example of allocation of uplink and downlink transmission resources in accordance with various embodiments of the present disclosure;

FIG. 5 illustrates a flowchart of a method performed by a UE in accordance with various embodiments of the present disclosure;

FIG. 6 illustrates an example of a method for identifying available frequency domain resources in accordance with various embodiments of the present disclosure;

FIG. 7 illustrates another example of a method for identifying available frequency domain resources in accordance with embodiments of the present disclosure;

FIG. 8 illustrates a flowchart of a method performed by a base station in accordance with embodiments of the present disclosure;

FIG. 9 illustrates a UE in accordance with various embodiments of the present disclosure; and

FIG. 10 illustrates a base station in accordance with various embodiments of the present disclosure.

### DETAILED DESCRIPTION

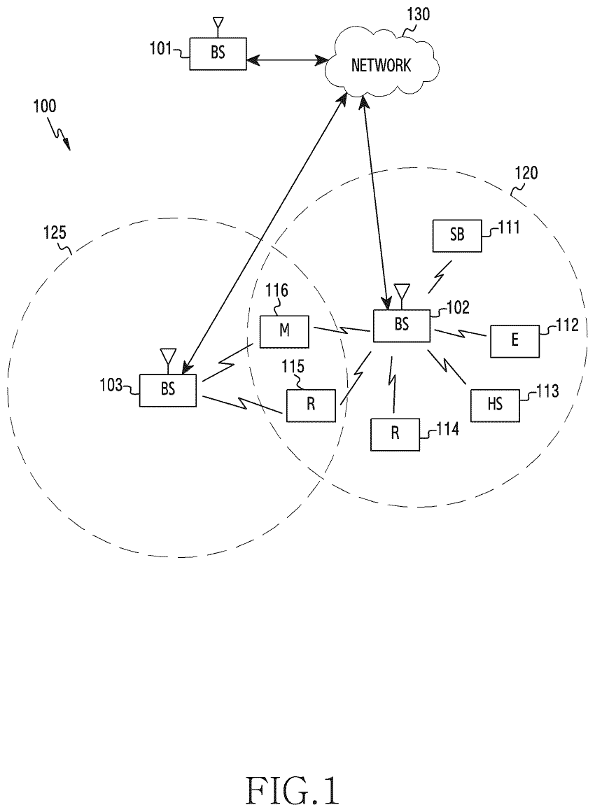

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Before undertaking the description below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. Embodiments of the present disclosure are described below in detail with reference to the accompanying drawings. It should be noted that, as far as possible, identical or similar elements are represented by the same or similar reference numerals. In addition, known features or configurations that may make the subject matter of the present disclosure unclear will not be described again in detail.

When describing embodiments of the present disclosure, technologies well known in the art and not directly related to the present disclosure will not be described. This omission of unnecessary descriptions is intended to prevent obscuration of the main idea of the present disclosure and to convey the main idea more clearly.

For the same reason, some elements may be enlarged, omitted, or schematically shown in the drawings. In addition, size of each element may not fully reflect the actual size. In a drawing, a same or corresponding element is represented by a same reference numeral.

The advantages and characteristics of the present disclosure and implementations thereof are apparent from the detailed description below of embodiments made with reference to the accompanying drawings. However, the present disclosure is not limited to the embodiments described below, but may be implemented in various forms. The following embodiments are provided only for the purpose of fully disclosing the present disclosure and informing those skilled in the art of the scope of the present disclosure, and that the present disclosure is limited only by the scope of the attached claims. Throughout the description, the same or similar reference numerals refer to the same or similar elements. FIG. 1 illustrates an example of a wireless communication network 100 according to various embodiments of the present disclosure. The embodiment of the wireless communication network 100 shown in FIG. 1 is for illustration only. Other embodiments of the wireless communication network 100 can be used without departing from the scope of the present disclosure.

The wireless communication network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” (BS) or “access point” (AP) can be used instead of “gNodeB” or “gNB.” For convenience, the terms “gNodeB” and “gNB” are used in the present disclosure to refer to network infrastructure components that provide wireless access for remote terminals. In addition, depending on the type of the network, other well-known terms such as “mobile station,” “user station,” “remote terminal,” “wireless terminal” or “user apparatus” can be used instead of “user equipment” or “UE.” For convenience, the terms “user equipment” and “UE” are used in the present disclosure to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of user equipments (UE) within a coverage area 120 of the gNB 102. The first plurality of UEs include a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UE within a coverage area 125 of the gNB 103. The second plurality of UEs include a UE 115 and a UE 116. In some embodiments, one or more of the gNBs 101-103 may communicate with each other and with the UEs 111-116 by using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of the gNB 101, the gNB 102, and the gNB 103 include a 2D antenna array as described in embodiments of this disclosure. In some embodiments, one or more of the gNB 101, the gNB 102, and the gNB 103 support codebook designs and structures for systems with 2D antenna arrays.

Although FIG. 1 illustrates an example of the wireless communication network 100, various changes may be made to FIG. 1. For example, the wireless communication network 100 may include any number of gNBs and any number of UEs in any suitable arrangement. Furthermore, the gNB 101 may directly communicate with any number of UEs and provide wireless broadband access to the network 130 for those UEs. Similarly, each of the gNB 102-103 may directly communicate with the network 130 and provide direct wireless broadband access to the network 130 for the UEs. In addition, the gNBs 101, gNB 102 and/or gNB 103 may provide access to other or additional external networks, such as external telephone networks or other types of data networks.

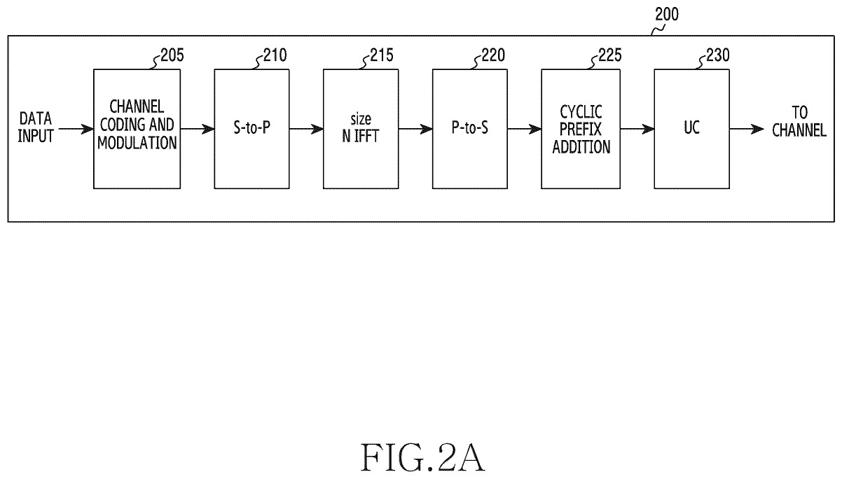

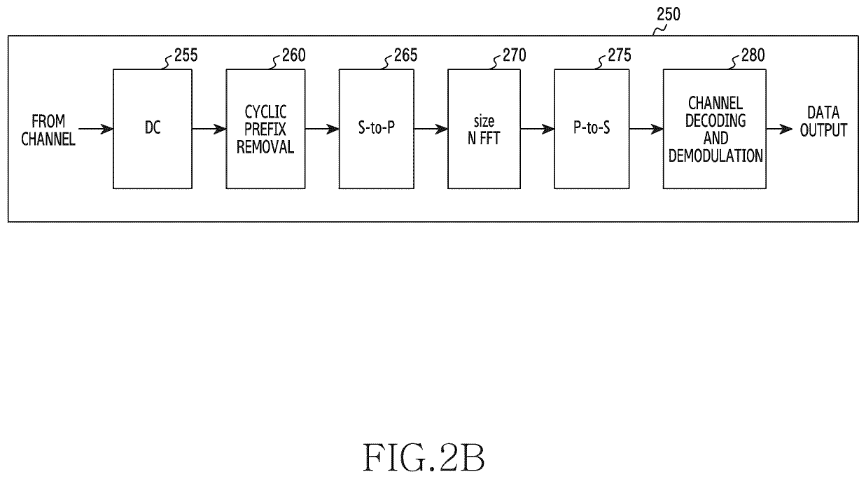

FIGS. 2A and 2B illustrate examples of a transmission path 200 and a reception path 250 in a wireless communication network in accordance with various embodiments of the present disclosure. In the following description, a transmission path 200 may be described as being embodied in a gNB, such as the gNB 102, and a reception path 250 may be described as being embodied in a UE, such as the UE 116. However, it should be understood that the reception path 250 may be embodied in a gNB and the transmission path 200 may be embodied in a UE. In some embodiments, the reception path 250 is configured to support codebook designs and structures for systems with 2D antenna arrays as described in embodiments of this disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in the gNB 102 and the UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. It may also filter the signal at a baseband before converting to the RF frequency.

The RF signal transmitted from the gNB 102 arrives at the UE 116 after passing through the wireless channel, and operations in reverse to those at the gNB 102 are performed at the UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signals into a sequence of modulated data symbols. The channel decoding and demodulation block 280 demodulates and decodes the modulated symbols to recover the original input data stream.

Each of the gNBs 101-103 may implement a transmission path 200 similar to that for transmitting to the UEs 111-116 in a downlink, and may implement a reception path 250 similar to that for receiving from the UEs 111-116 in an uplink. Similarly, each of the UEs 111-116 may implement a transmission path 200 for transmitting to the gNBs 101-103 in an uplink, and may implement a reception path 250 for receiving from the gNBs 101-103 in a downlink.

Each of the components in FIGS. 2A and 2B may be embodied in only hardware, or in a combination of hardware and software/firmware. As a specific example, at least some of the components in FIGS. 2A and 2B may be embodied in software, while other components may be embodied in configurable hardware or a combination of software and configurable hardware. For example, the FFT block 270 and IFFT block 215 may be embodied as configurable software algorithms, in which the value of the size N may be modified according to the implementation.

Furthermore, although described as using FFT and IFFT, this is only illustrative and should not be interpreted as limiting the scope of this disclosure. Other types of transforms may be used, such as discrete Fourier transform (DFT) and Inverse Discrete Fourier Transform (IDFT) functions. It should be understood that for DFT and IDFT functions, the value of variable N may be any integer (such as 1, 2, 3, 4), while for FFT and IFFT functions, the value of variable N may be any integer which is a power of 2 (such as 1, 2, 4, 8, 16).

Although FIGS. 2A and 2B illustrate examples of wireless transmission and reception paths, various changes may be made to FIGS. 2a and 2b. For example, various components in FIGS. 2A and 2B may be combined, further subdivided or omitted, and additional components may be added according to specific requirements. In addition, FIGS. 2A and 2B are intended to illustrate examples of types of transmission and reception paths that can be used in a wireless network. Any other suitable architecture may be used to support wireless communication in a wireless network.

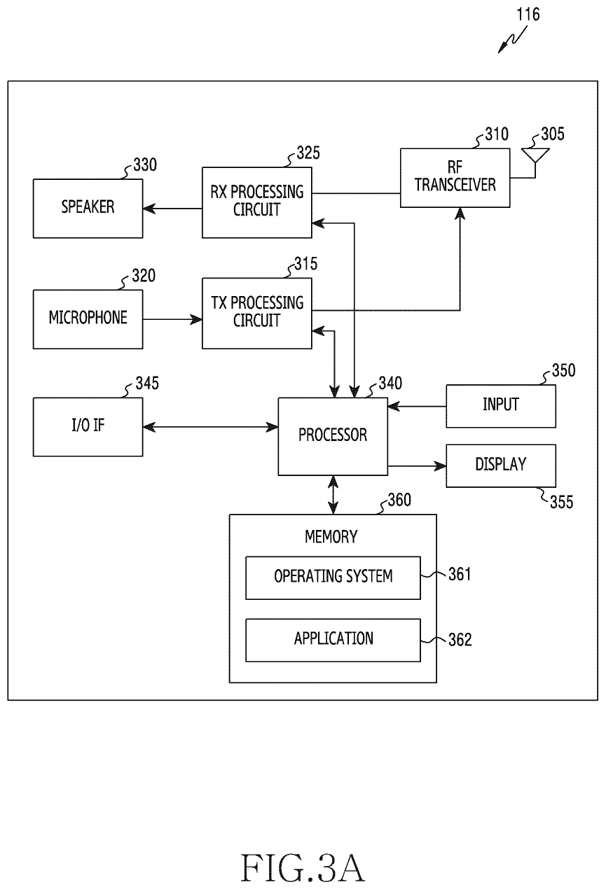

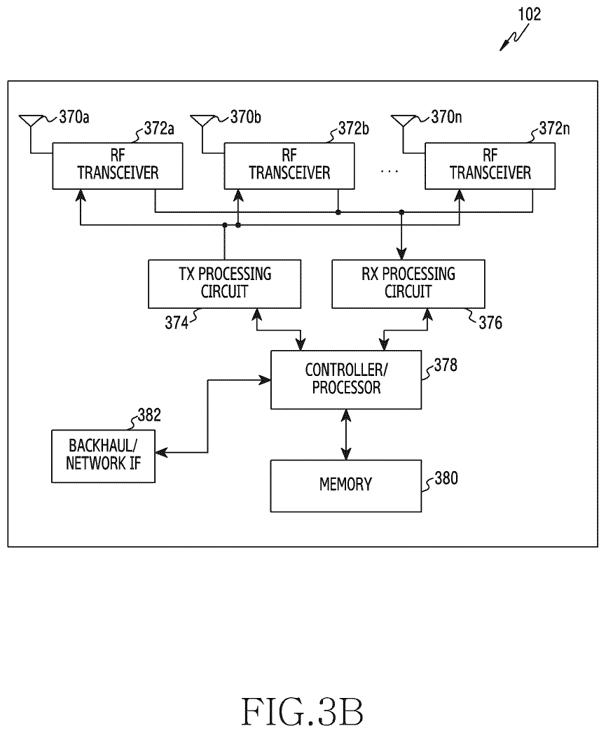

FIG. 3A illustrates an example of UE 116 in accordance with various embodiments of the present disclosure. The embodiment of the UE 116 shown in FIG. 3A is for illustration only, and the UEs 111-115 of FIG. 1 may have the same or similar configuration. However, a UE has various configurations, and FIG. 3A does not limit the scope of this disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to the speaker 330 (such as for voice data) or to the processor/controller 340 for further processing (such as for web browsing data).

The TX processing circuit 315 receives analog or digital voice data from the microphone 320 or other outgoing baseband data (such as network data, email or interactive video game data) from the processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 may include one or more processors or other processing devices and execute an OS 361 stored in the memory 360 in order to control the overall operation of the UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of this disclosure. The processor/controller 340 can move data into or out of the memory 360 as required by an execution process. In some embodiments, the processor/controller 340 is configured to execute the application 362 based on the OS 361 or in response to signals received from the gNB or the carrier. The processor/controller 340 is also coupled to an I/O interface 345, where the I/O interface 345 provides UE 116 with the ability to connect to other devices such as laptop computers and handheld computers. The I/O interface 345 is a communication path between these accessories and the processor/controller 340.

The processor/controller 340 is also coupled to the input device(s) 350 and the display 355. An operator of the UE 116 can input data into the UE 116 using the input device(s) 350. The display 355 may be a liquid crystal display or another display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of the UE 116, various changes may be made to FIG. 3A. For example, various components in FIG. 3A may be combined, further subdivided or omitted, and additional components may be added according to specific requirements. As a specific example, the processor/controller 340 can be divided into a plurality of processors, such as one or more central processing units (CPU) and one or more graphics processing units (GPU). In addition, although FIG. 3A illustrates that the UE 116 is configured as a mobile phone or a smart phone, the UEs may be configured to operate as other types of mobile or fixed devices.

FIG. 3B illustrates an example of the gNB 102 in accordance with various embodiments of the present disclosure. The embodiment of the gNB 102 shown in FIG. 3B is for illustration only, and other gNBs of FIG. 1 may have the same or similar configuration. However, a gNB has various configurations, and FIG. 3B does not limit the scope of this disclosure to any specific implementation of a gNB. It should be noted that the gNB 101 and the gNB 103 may include the same or similar structures as the gNB 102.

As shown in FIG. 3B, the gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, a memory 380, and a backhaul or network interface 382.

The RF transceivers 372a-372n receive an incoming RF signal from the antennas 370a-370n, such as a signal transmitted by a UE or another gNB. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to the controller/processor 378 for further processing.

The TX processing circuit 374 receives analog or digital data (such as voice data, network data, email, or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from the TX processing circuit 374 and up-convert the baseband or IF signal into an RF signal transmitted via the antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process such as that performed through a BIS algorithm, and decode a received signal from which an interference signal is subtracted. A controller/processor 378 may support any of a variety of other functions in the gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of this disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). For example, when the gNB 102 is embodied as a part of a cellular communication system, such as a cellular communication system supporting 5G or new radio access technology or NR, LTE or LTE-A, the backhaul or network interface 382 may allow the gNB 102 to communicate with other gNBs through wired or wireless backhaul connections. When the gNB 102 is embodied as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions is configured to cause the controller/processor 378 to execute the BIS process and decode the received signal after subtracting at least one interference signal determined by the BIS algorithm.

As will be described in more detail below, the transmission and reception paths of the gNB 102 (embodied by using the RF transceivers 372a-372n, the TX processing circuit 374 and/or the RX processing circuit 376) support aggregated communication with FDD cells and TDD cells.

Although FIG. 3B illustrates an example of gNB 102, various changes may be made to FIG. 3B. For example, the gNB 102 can include any number of each component shown in FIG. 3B. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

Exemplary embodiments of the present disclosure are further described below with reference to the accompanying drawings.

The text and drawings are provided as examples only to help readers understand this disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the present disclosure.

Communication systems are usually divided into time domain duplexing (TDD) and frequency domain duplexing (FDD) systems. In a TDD system, a base station can configure uplink and downlink attributes of different time resources on a carrier through semi-static signaling and dynamic signaling, that is, an uplink transmission time slot/symbol, a downlink transmission time slot/symbol, and a flexible time slot/symbol. In an FDD system, a base station can configure different time resources of an uplink carrier in a pair of uplink and downlink carriers as an uplink transmission time slot/symbol or a flexible time slot/symbol, and different time resources of a downlink carrier in a pair of uplink and downlink carriers as a downlink transmission time slot/symbol or a flexible time slot/symbol.

The semi-static signaling may be a higher-layer signaling. The dynamic signaling may be group-common downlink control information (DCI) that does not schedule a physical downlink shared channel (PDSCH) and a physical uplink shared channel (PUSCH). The dynamic signaling may also be DCI that schedules a physical downlink shared channels (PDSCH) and physical uplink shared channels (PUSCH).

Compared with the FDD system, the TDD system has higher time delay in an uplink or downlink transmission due to the time-division multiplexing of the uplink or downlink transmission. For example, according to an uplink and downlink configuration, in a period of 10 millisecond (ms), only a time slot of 1 ms is used for uplink transmission, and other times slots are used for downlink or flexible transmissions, the delay in uplink transmission is up to 10 ms. In order to reduce the transmission delay, it may be considered to assign some of the frequency domain resources in one carrier for uplink transmission and other resources for downlink transmission. In order to reduce the interference between uplink and downlink transmissions in a same carrier, the uplink and downlink interference can be reduced by means of guard interval.

In a wireless communication system, frequency domain resources in a time period (for example, one or more time slots, or one or more symbols (such as OFDM symbols), or the like) may be configured as uplink frequency domain resources or downlink frequency domain resources. If frequency domain resources for a downlink transmission (or an uplink transmission) are scheduled, it is desirable to enhance the way in which the frequency domain resources that are actually used for the downlink transmission (or the uplink transmission) are determined. For example, if frequency domain resources in a time period are configured with uplink and downlink frequency domain resources, and there are frequency domain resources that cannot be used for downlink transmission (or uplink transmission) among the frequency domain resources that are scheduled for downlink transmission (or uplink transmission), then the frequency domain resources that are actually used for downlink transmission (or uplink transmission) cannot be determined. In a wireless communication system, in order to determine the frequency domain resources that can be used for downlink transmission (or uplink transmission) among the frequency domain resources scheduled for downlink transmission (or uplink transmission) and further improve the utilization of resources, the present application provides a method for determining frequency domain resources that are actually used for downlink transmission (or uplink transmission). Through the method provided in the present application, the transmission performance of data may be guaranteed and the resources may be utilized as much as possible under the premise of ensuring data transmission performance.

In the present application, on the UE side, an uplink transmission may also be referred as the uplink transmitting, and a downlink transmission may also be referred as a downlink reception, while on the base station side, an uplink transmission may also be referred as an uplink reception, and a downlink transmission may also be referred as a downlink transmitting, the naming of which is not limited in the present application.

In a TDD system, a base station may indicate that a time slot or a symbol (such as an OFDM symbol) is an uplink symbol, or a downlink symbol, or a flexible transmission symbol, and a UE determines the transmission direction (uplink/downlink) of each symbol/time slot of a carrier/service cell based on indications from the base station. Typically, in a same symbol of a carrier/service cell, only one direction of transmission, that is, uplink transmission or downlink transmission, is supported, so a base station only needs to indicate the uplink/downlink transmission direction in time dimension. The base station may periodically indicate, for example, a periodic slot configuration through a higher-layer signaling, or a slot format over a time period through dynamic signaling (e.g., downlink control information DCI), or whether the scheduled resources are suitable for uplink transmission or downlink reception through a scheduling indication. The uplink and downlink attributes of each frequency domain resource in each time slot/symbol are determined through the time slot configuration/time slot format, where the uplink and downlink attributes include: for uplink transmission, for downlink transmission, or for flexible transmission. A flexible time slot/symbol may be used for both uplink and downlink transmissions, but only for one direction at a given moment.

In an FDD system, a base station may indicate an uplink or flexible transmission symbol/time slot for an uplink carrier/service cell, and the base station may indicate a downlink or flexible transmission symbol/time slot for a downlink carrier/service cell. Cell-common UL/DL information may include information on the uplink and downlink attributes in time dimension, and the cell-common UL/DL information may be used to indicate a period, and which time slots/symbols in the period are uplink, downlink, or flexible time slots/symbols, respectively, and the indicated uplink and downlink attributes are applicable to all frequency domain resources in each time slot/symbol of the cell, that is, all frequency domain resources in the bandwidth of the carrier/service cell have the same uplink and downlink attributes in a time slot/symbol.

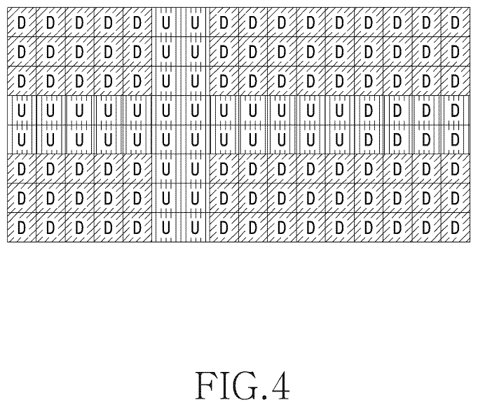

In order to allocate uplink and downlink transmission resources more efficiently, a granularity of uplink and downlink transmission resources may be further narrowed from a symbol/time slot to a part of the frequency domain resources in a symbol/time slot, that is, different frequency domain resources in a symbol of a carrier/service cell may be allocated with different transmission directions. The configuration information includes cell-common UL/DL information and/or UE-specific UL/DL information. The cell-common UL/DL information may include information on the uplink and downlink attributes in time dimension and the frequency domain dimension, and the cell-common UL/DL information may be used to indicate which frequency domain resources of which time slots/symbols are uplink, downlink, or flexibly transmission resources. Alternatively, the common UL/DL information may be used to indicate which frequency domain resources of which time slots/symbols are used for uplink transmission, downlink transmission, or cannot be used for transmission. The base station may also be configured with UE-specific UL/DL information, for example, for each service cell of the UE, or for each bandwidth part (BWP) of the UE. According to the configured UL/DL information, the UE may determine that in a symbol or a time slot, some frequency domain resources are uplink transmission resources and some frequency domain resources are downlink transmission resources, as shown in FIG. 4. It may also determine that all frequency domain resources in a symbol or a time slot are uplink transmission resources, or all frequency domain resources in a symbol or a time slot are downlink transmission resources. The configuration information may be semi-static signaling, that is, higher-layer signaling.

In addition, dynamic signaling may also be used to indicate which frequency domain resources of which time slots/symbols are for uplink, downlink or guard band. For example, a group-common downlink control information indicates that a part of the frequency domain resources in each time slot/symbol are for uplink, downlink or guard band. Alternatively, some frequency domain resources are indicated as uplink and downlink resources through DCI scheduling the PDSCH or PUSCH dynamically. For example, the frequency domain resources scheduled by the DCI scheduling the PDSCH are downlink resources, and the frequency domain resources scheduled by the DCI scheduling the PUSCH are uplink resources.

The frequency domain resources scheduled by the DCI scheduling the PDSCH or PUSCH may be determined through indicating a resource block group (RBG) by a bitmap, i.e., dividing frequency domain resources of a BWP into at least one RBG, and then using 1-bit information to indicate whether the RBG corresponding to that bit is scheduled. For example, when the bit is “0,” the frequency domain resources in the RBG corresponding to the bit is not scheduled, and when the bit is “1,” the frequency domain resources in the RBG corresponding to bit are scheduled. The nominal size of a RBG in a BWP is P, sizes of the first and last RBGs in a BWP may be less than or equal to P, and the sizes of the RBGs in the BWP other than the first and last RBG are equal to P. For example, a BWP contains 46 resource blocks (RBs) (or physical resource blocks (PRBs)). The nominal size of a RBG is 4, and this BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG.

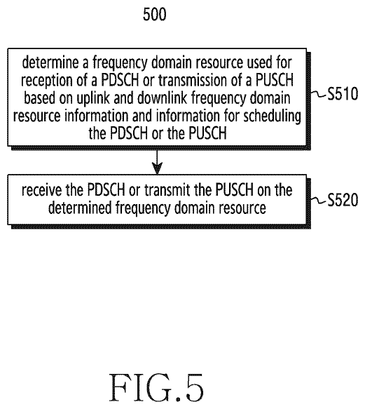

FIG. 5 illustrates an exemplary flowchart of a method 500 for receiving a PDSCH or transmitting a PUSCH in accordance with various embodiments of the present disclosure. The method 500 is implemented on the UE side.

As shown in FIG. 5, in step S510, the UE determines frequency domain resources used for receiving a PDSCH or transmitting a PUSCH based on uplink and downlink frequency domain resource information used to indicate uplink and downlink frequency domain resources (e.g., configuration/indication information used to indicate uplink and downlink attributes of a part of frequency domain resources within a symbol/time slot) and information scheduling a PDSCH or a PUSCH (e.g., DCI scheduling a PDSCH or a PUSCH as described above).

In step S520, the PDSCH received or the PUSCH is transmitted on the determined frequency domain resources for receiving the PDSCH or the frequency domain resources for transmitting the PUSCH.

Specifically, in step S510, the uplink and downlink frequency domain resource information may be obtained by receiving semi-static signaling, which may be higher-layer signaling or media access layer signaling. The uplink and downlink frequency domain resource information may be obtained by receiving dynamic signaling. The dynamic signaling may be group-common downlink control information (DCI) that does not schedule a physical downlink shared channel (PDSCH) and a physical uplink shared channel (PUSCH). The dynamic signaling may also be DCI that schedules a physical downlink shared channels (PDSCH) or physical uplink shared channels (PUSCH).

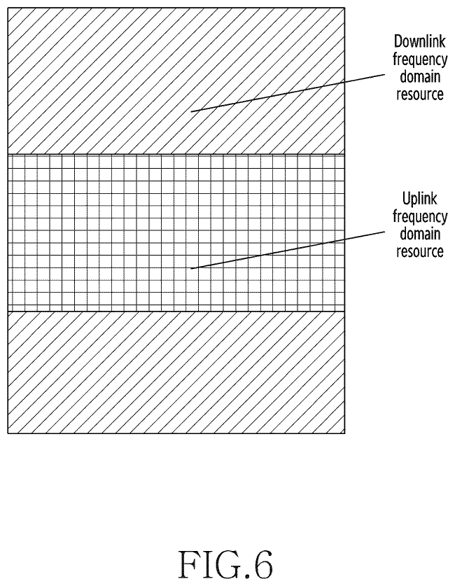

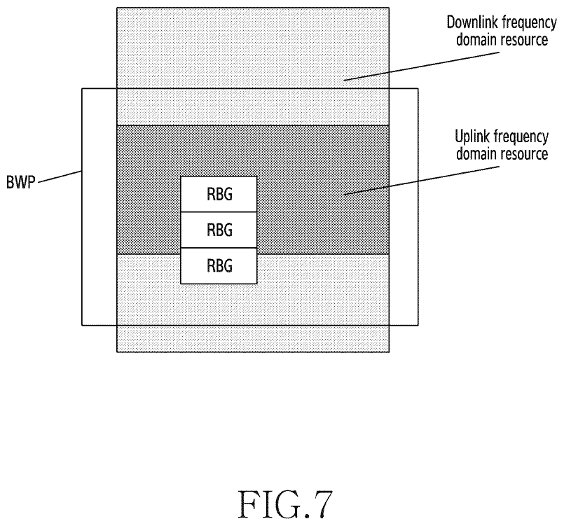

The following describes methods for determining PDSCH resources in case that a PDSCH is dynamically scheduled, semi-persistent scheduled (SPS), and is determined by configured grant (CG), as shown in FIGS. 6 and 7. The following description uses an example of a method for determining the PDSCH resources. It should be understood that the method described herein may also be used for PUSCH, for example, by replacing the description of PDSCH with the description of PUSCH. In the present application, the descriptions of various information and resources are not limited by their names. For example, the “scheduling information of PDSCH resources” described below may derive the “scheduling information of PUSCH resources” by replacing the description of PDSCH with the description of PUSCH; the information used to schedule frequency domain resources, for example, the scheduling information of PDSCH resources and the scheduling information of PUSCH resources, may be referred as “first information”; the “uplink and downlink frequency domain resource information” may be referred as “second information”; the “PDSCH resources” may derive the “PUSCH resources” by replacing the description of PDSCH with a description of PUSCH, and frequency domain resources such as the “PDSCH resources” and “PUSCH resources” may be referred as “first frequency domain resources”; and the “uplink and downlink frequency domain resources” may be referred as “second frequency domain resources.”

### Embodiment 1

Embodiment 1 describes a method for allocating PDSCH resources in the case that a PDSCH is scheduled dynamically.

### Method 1:

According to the uplink and downlink frequency domain resource information and the scheduling information of PDSCH resources, frequency domain resources for receiving a PDSCH are determined. Specifically, it includes at least one of the following methods.

1. When the uplink and downlink frequency domain resource information is obtained through semi-static information (for example, a RRC message), frequency domain resources that may be used for downlink transmission in the frequency domain resources for the scheduled PDSCH are determined based on the uplink and downlink frequency domain resource information, and the PDSCH is received on the determined frequency domain resources.

Specifically, if it is determined that a part of the frequency domain resources for the scheduled PDSCH are downlink frequency domain resources, and another part of the frequency domain resources are uplink resources or guard band resources or frequency domain resources that cannot be used for downlink reception, the UE only receives the PDSCH on the downlink frequency domain resources in the frequency domain resources for the scheduled PDSCH, and the UE does not receive the PDSCH on the uplink frequency domain resources or guard band resources or on the frequency domain resources that cannot be used for downlink reception in the frequency domain resources for the scheduled PDSCH.

For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled. It is determined through higher-layer signaling that the first to tenth PRBs in the 46 PRBs (e.g., uplink and downlink frequency domain resources) are located in the uplink frequency domain resources, and the eleventh to forty-sixth PRBs in the 46 PRBs are located in the downlink frequency domain resources, so that in the third RBG, the fourth RBG, the fifth RBG and the sixth RBG in the frequency domain resources for the scheduled PDSCH, the first PRB, the second PRB and the third PRB in the third RBG are located in the uplink frequency domain resources, the fourth PRB in the third RBG is located in the downlink frequency domain resources, and the fourth RBG, the fifth RBG and the sixth RBG for the scheduled PDSCH are located in the downlink frequency domain resources, at this time, the UE receives the PDSCH on the downlink frequency domain resources in the frequency domain resources for the scheduled PDSCH, that is, the fourth PRB in the third RBG, the fourth RBG, the fifth RBG and the sixth RBG, and does not receive the PDSCH on the first PRB, the second PRB and the third PRB in the third RBG located in the uplink frequency domain resources in the frequency domain resources for the scheduled PDSCH.

If it is determined, based on the uplink and downlink frequency domain resource information, that all frequency domain resources for the scheduled PDSCH are downlink frequency domain resources, the UE receives PDSCH on all frequency domain resources for the scheduled PDSCH.

For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled. It is determined through higher-layer signaling that the first to forty-sixth PRBs (for example, uplink and downlink frequency domain resources) are all located in the downlink frequency domain resources, at this time, the UE receives the PDSCH on all frequency domain resources in the frequency domain resources for the scheduled PDSCH, that is, the third RBG, the fourth RBG, the fifth RBG and the sixth RBG.

By this method, the base station and the UE may take full advantage of the available frequency domain resources without causing a different understanding of the available resources by the base station and the UE.

2. When the uplink and downlink frequency domain resource information is obtained through dynamic information, frequency domain resources that may be used for downlink transmission in the frequency domain resources for the scheduled PDSCH are determined based on the uplink and downlink frequency domain resource information, and the PDSCH is received on the determined frequency domain resources.

Specifically, if it is determined that a part of the frequency domain resources for the scheduled PDSCH are downlink frequency domain resources, and another part of the frequency domain resources are uplink resources or guard band resources or frequency domain resources that cannot be used for downlink reception, the UE only receives the PDSCH on the downlink frequency domain resources in the frequency domain resources for the scheduled PDSCH, and the UE does not receive the PDSCH on the uplink frequency domain resources or guard band resources or on the frequency domain resources that cannot be used for downlink reception in the frequency domain resources for the scheduled PDSCH.

For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled.

It is determined through higher-layer signaling that the first to tenth PRBs in the 46 PRBs (e.g., uplink and downlink frequency domain resources) are located in the uplink frequency domain resources, and the eleventh to forty-sixth PRBs in the 46 PRBs are located in the downlink frequency domain resources, so that in the third RBG, the fourth RBG, the fifth RBG and the sixth RBG in the frequency domain resources for the scheduled PDSCH, the first PRB, the second PRB and the third PRB in the third RBG are located in the uplink frequency domain resources, the fourth PRB in the third RBG is located in the downlink frequency domain resources, and the fourth RBG, the fifth RBG and the sixth RBG for the scheduled PDSCH are located in the downlink frequency domain resources, at this time, the UE receives the PDSCH on the downlink frequency domain resources in the frequency domain resources for the scheduled PDSCH, that is, the fourth PRB in the third RBG, the fourth RBG, the fifth RBG and the sixth RBG, and does not receive the PDSCH on the first PRB, the second PRB and the third PRB in the third RBG located in the uplink frequency domain resources in the frequency domain resources for the scheduled PDSCH.

If it is determined, based on the uplink and downlink frequency domain resource information, that all frequency domain resources for the scheduled PDSCH are downlink frequency domain resources, the UE receives PDSCH on all frequency domain resources for the scheduled PDSCH.

For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled. It is determined through higher-layer signaling that the first to forty-sixth PRBs (for example, uplink and downlink frequency domain resources) are all located in the downlink frequency domain resources, at this time, the UE receives the PDSCH on all frequency domain resources in the frequency domain resources for the scheduled PDSCH, that is, the third RBG, the fourth RBG, the fifth RBG and the sixth RBG.

By this method, the base station and the UE may take full advantage of the available frequency domain resources without causing a different understanding of the available resources by the base station and the UE.

3. When the uplink and downlink frequency domain resource information is obtained through dynamic information, the frequency domain resources for the dynamically scheduled PDSCH are in a preset or configured uplink and downlink frequency domain resource format, and the UE performs the uplink and downlink transmissions on the frequency domain resources for the scheduled PDSCH in the preset or configured uplink and downlink frequency domain resource format.

For example, an assumption may be that the frequency domain resources for the dynamically scheduled PDSCH are all downlink frequency domain resources. For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled.

Regardless of whether the uplink and downlink frequency domain resource information indicates that the third RBG, the fourth RBG, the fifth RBG and the sixth RBG are all downlink frequency domain resources through dynamic information, or the dynamic information indicates that a part of the third RBG, the fourth RBG, the fifth RBG and the sixth RBG are uplink frequency domain resources, the UE receives the PDSCH on all frequency domain resources of the third RBG, the fourth RBG, the fifth RBG and the sixth RBG. By this method, the UE considers all dynamically scheduled frequency domain resources are resources that can be used to receive the PDSCH.

By this method, available frequency domain resources may be fully utilized.

4. When the uplink and downlink resource indication (for example, uplink and downlink resource information) is not configured or the UE does not receive the uplink and downlink resource indication (for example, uplink and downlink resource information), the UE receives the PDSCH on all dynamically scheduled frequency domain resources for the PDSCH.

In this method, the frequency domain resources for the dynamically scheduled PDSCH are in a preset or configured uplink and downlink frequency domain resource format. For example, an assumption may be that the frequency domain resources for the dynamically scheduled PDSCH are all downlink frequency domain resources. For example, a BWP contains 46 RBs, a nominal RBG size of a RBG is 4, and the BWP contains 12 RBGs, wherein the size of the first RBG is 3, the size of the 12th RBG is 3, and the sizes of the remaining RBGs are 4. 12 bits in the DCI are used to indicate the frequency domain resource scheduling, referred as a frequency domain resource assignment (FDRA) field. The first bit in the frequency domain resource assignment field indicates the scheduling of the first RBG, the second bit in the frequency domain resource assignment field indicates the scheduling of the second RBG, and so on, and the 12th bit in the frequency domain resource assignment field indicates the scheduling of the 12th RBG. The value of 12 bits in the DCI scheduling the PDSCH is “001111000000,” that is, the third RBG, the fourth RBG, the fifth RBG and the sixth RBG are scheduled, and the remaining 8 RBGs are not scheduled. The UE receives the PDSCH on all frequency domain resources of the third RBG, the fourth RBG, the fifth RBG and the sixth RBG. In other words, the UE considers all dynamically scheduled frequency domain resources are resources that can be used to receive the PDSCH.

By this method, a different understanding of the available resources by the base station and the UE will not be caused.

### Method 2:

If DCI scheduling the PDSCH transmission includes scheduling information of PDSCH resources (for example, FDRA) and uplink and downlink frequency domain resource information, the UE determines the frequency domain resources for receiving the PDSCH based on the uplink and downlink frequency domain resource information and the scheduling information of the PDSCH resources in the DCI scheduling the PDSCH transmission.

A possible scheme is that the UE receives higher-layer signaling configuration, obtains N uplink and downlink frequency domain resource configuration formats, and the number of bits of the uplink and downlink frequency domain resource information in the DCI scheduling the PDSCH resource is equal to a value obtained by rounding up N (log 2(N)). For example, N is equal to 2 and the value obtained by rounding up N (log 2(2)) is equal to 1, when the bit value is “0,” the uplink and downlink frequency domain resource configuration format is that all frequency domain resources in the entire frequency domain are downlink frequency domain resources; and when the bit value is “1,” the uplink and downlink frequency domain resource configuration format is that the first to tenth PRBs in the 46 PRBs in the entire frequency domain are located in the uplink frequency domain resources, and the eleventh to forty-sixth PRBs in the 46 PRBs are located in the downlink frequency domain resources.

When the value of 12 bits in the DCI scheduling the PDSCH is “001111000000” and the bit value for the uplink and downlink frequency domain resource information in the DCI is “0,” the uplink and downlink frequency domain resource configuration format is that all frequency domain resources in the entire frequency domain are downlink frequency domain resources, that is, the third RBG, the fourth RBG, the fifth RBG and the sixth RBG are scheduled, and the third RBG, the fourth RBG, the fifth RBG and the sixth RBG are all downlink resources, and the UE receives the PDSCH on all frequency domain resources in the third RBG, the fourth RBG, the fifth RBG and the sixth RBG.

When the value of 12 bits in the DCI scheduling a PDSCH is “001111000000” and the bit value for the uplink and downlink frequency domain resource information in the DCI is “1,” the uplink and downlink frequency domain resource configuration format is that the first to tenth PRBs in the 46 PRBs in the entire frequency domain are located in the uplink frequency domain resources, and the eleventh to forty-sixth PRBs in the 46 PRBs are located in the downlink frequency domain resources, that is, the third RBG, the fourth RBG, the fifth RBG and the sixth RBG are scheduled and the fourth PRB in the third RBG is located in the downlink frequency domain resource, the fourth RBG, the fifth RBG and the sixth RBG for the scheduled PDSCH are all located in the downlink frequency domain resources, and the UE receives the PDSCH on the frequency domain resources in the fourth PRB of the third RBG, the fourth RBG, the fifth RBG and the sixth RBG.

By this method, the base station and the UE may take full advantage of the available frequency domain resources without causing a different understanding of the available resources by the base station and the UE.

### Embodiment 2

This embodiment describes a method for determining PDSCH resources in the case that a PDSCH is semi-persistent scheduled (SPS).

### Method 1:

When a UE receives uplink and downlink frequency domain resource information, the UE determines frequency domain resources for receiving the PDSCH based on the received uplink and downlink frequency domain resource information and the PDSCH resources indicated by a semi-persistent scheduling (SPS). For example, the UE receives the PDSCH in PDSCH resources indicated by the SPS and in downlink frequency domain resources indicated by the uplink and downlink frequency domain resource information; or
when the uplink and downlink frequency domain resource information is not configured or the UE does not receive the uplink and downlink frequency domain resource information, the UE receives the PDSCH in the PDSCH resources indicated by the SPS. Alternatively, when the uplink and downlink frequency domain resource information is not configured or the UE does not receive the uplink and downlink frequency domain resource information, the UE does not receive the PDSCH or the UE does not receive the PDSCH on the PDSCH resources indicated by the SPS.

### Method 2:

When the UE receives the uplink and downlink frequency domain resource information, the UE determines frequency domain resources for receiving the PDSCH based on the received uplink and downlink frequency domain resource information and the PDSCH resources indicated by the SPS. Specifically, the method 2 includes at least one of the following methods:
when the SPS indicates PDSCH resources and a ratio of the downlink frequency domain resources indicated by the uplink and downlink frequency domain resource information in the PDSCH resources indicated is greater than or equal to a threshold, the UE receives the PDSCH in the PDSCH resources indicated by the SPS and in the downlink frequency domain resources indicated by the uplink and downlink frequency domain resource information;
when the SPS indicates PDSCH resources and the ratio of the downlink frequency domain resources indicated by the uplink and downlink frequency domain resource information in the PDSCH resources indicated is less than a threshold (for example, the downlink frequency domain resources indicated by the uplink and downlink frequency domain resource information received by the UE are insufficient for PDSCH reception), the UE does not receive the PDSCH or the UE does not receive the PDSCH on the PDSCH resources indicated by the SPS; and
when the uplink and downlink frequency domain resource information is not configured or the UE does not receive the uplink and downlink frequency domain resource information, the UE determines frequency domain resources for receiving the PDSCH in the PDSCH resources indicated by the SPS. Alternatively, when the UE does not receive the uplink and downlink frequency domain resource information, the UE does not receive the PDSCH or the UE does not receive the PDSCH on the PDSCH resources indicated by the SPS.

In Embodiment 2, the uplink and downlink frequency domain resource information may be obtained through semi-static information (e.g., RRC, etc.) or through dynamic information (e.g., DCI or MAC CE, etc.).

### Embodiment 3

This embodiment describes a method for determining PDSCH resources in the case that a PDSCH is a configured grant (CG).

### Method 1:

When a UE receives uplink and downlink frequency domain resource information, the UE determines frequency domain resources for receiving the PDSCH based on the received uplink and downlink frequency domain resource information and the PDSCH resources indicated by the configured grant (CG). For example, the UE receives the PDSCH in the PDSCH resources indicated by the CG and in downlink frequency domain resources indicated by the uplink and downlink frequency domain resource information; or
when the uplink and downlink frequency domain resource information is not configured or the UE does not receive the uplink and downlink frequency domain resource information, the UE receives the PDSCH in the PDSCH resources indicated by the CG. Alternatively, when the uplink and downlink frequency domain resource information is not configured or the UE does not receive the uplink and downlink frequency domain resource information, the UE does not receive the PDSCH or the UE does not receive the PDSCH on the PDSCH resource indicated by the CG.

### Method 2:

When the UE receives the uplink and downlink frequency domain resource information, the UE determines frequency domain resources for receiving the PDSCH based on the received uplink and downlink frequency domain resource information and the PDSCH resources indicated by the CG. Specifically, Method 2 includes at least one of the following methods:
when the CG indicates PDSCH resources and a ratio of the downlink frequency domain resources indicated by the uplink and downlink frequency domain resource information in the PDSCH resources indicated is greater than or equal to a threshold, the UE receives the PDSCH in the PDSCH resources indicated by the CG and in the downlink frequency domain resources indicated by the uplink and downlink frequency domain resource information;
when the CG indicates PDSCH resources and the ratio of the downlink frequency domain resources indicated by the uplink and downlink frequency domain resource information in the PDSCH resources indicated is less than a threshold (for example, the downlink frequency domain resources indicated by the uplink and downlink frequency domain resource information received by the UE are insufficient for PDSCH reception), the UE does not receive the PDSCH or the UE does not receive the PDSCH on the PDSCH resources indicated by the CG; and
when the uplink and downlink frequency domain resource information is not configured or the UE does not receive the uplink and downlink frequency domain resource information, the UE determines the frequency domain resources for receiving the PDSCH in the PDSCH resources indicated by the CG. Alternatively, when the UE does not receive the uplink and downlink frequency domain resource information, the UE does not receive the PDSCH or the UE does not receive the PDSCH on the PDSCH resource indicated by the CG.

In Embodiment 3, the uplink and downlink frequency domain resource information may be obtained through semi-static information (e.g., RRC, etc.) or through dynamic information (e.g., DCI or MAC CE, etc.).

In the above Embodiments 1 to 3, the order of reception of the “uplink and downlink frequency domain resource information” and reception of the “scheduling information of the PDSCH resources” is not limited, the “uplink and downlink frequency domain resource information” may be received before the “scheduling information of the PDSCH resources,” or the “scheduling information of the PDSCH resources” may be received before the “uplink and downlink frequency domain resource information”; or both the “uplink and downlink frequency domain resource information” and the “scheduling information of the PDSCH resources” may be received simultaneously. Similarly, the order for the base station transmits the “uplink and downlink frequency domain resource information” and the “scheduling information of the PDSCH resources” is also not limited. In the present application, the reception (or transmission) of the “uplink and downlink frequency domain resource information” and the reception (or transmission) of the “scheduling information of the PDSCH resources” may be rearranged to implement the functions and effects disclosed in the present disclosure.

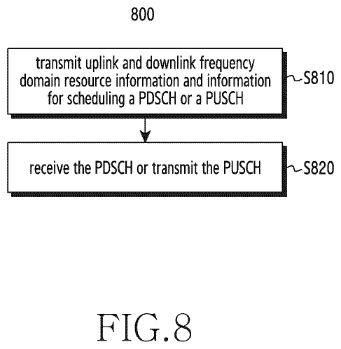

FIG. 8 illustrates a flowchart of a method 800 performed by a base station in accordance with various embodiments of the present disclosure.

As shown in FIG. 8, in step S810, the base station transmits, to a UE, information for indicating uplink and downlink frequency domain resources (e.g., configuration/indication information for indicating the uplink and downlink attributes of a part of the frequency domain resources within a symbol/time slot) and information scheduling a PDSCH or a PUSCH.

In step S820, the base station transmits the PDSCH or receives the PDSCH on the frequency domain resources for the PDSCH or the frequency domain resources for the PUSCH determined by the UE based on the uplink and downlink frequency domain resource information and the information scheduling the PDSCH or the PUSCH.

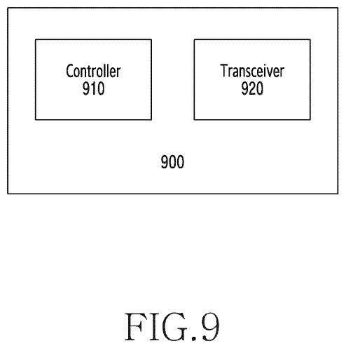

FIG. 9 illustrates a structure of a user equipment 900 in accordance with various embodiments of the present disclosure. As shown in FIG. 9, the user equipment 900 includes a controller 910 and a transceiver 920, where the controller 910 is configured to perform the method performed by the user equipment that is disclosed herein above, and the transceiver 920 is configured to transmit and receive a channel or a signal. Furthermore, the user equipment 900 further includes a memory. Additionally, the components of the user equipment 900 are not limited thereto. For example, the user equipment 900 may include more or fewer components than those described above. In addition, the controller 910 and the transceiver 920 and the memory may be implemented as a single chip. Also, the controller 910 may include at least one processor.

Furthermore, the user equipment 900 may correspond to user equipment of FIG. 3A, the controller 910 may correspond to a processor 340 of FIG. 3A, and the transceiver 920 may correspond to the RF transceiver 310 of FIG. 3A.

The transceiver 920 collectively refers to a UE receiver and a UE transmitter, and may transmit/receive a signal to/from a base station or a network entity. The signal transmitted or received to or from the base station or a network entity may include control information and data. The transceiver 920 may include a RF transmitter for up-converting and amplifying a frequency of a transmitted signal, and a RF receiver for amplifying low-noise and down-converting a frequency of a received signal. However, this is only an example of the transceiver 920 and components of the transceiver 920 are not limited to the RF transmitter and the RF receiver.

Also, the transceiver 920 may receive and output, to the controller 910, a signal through a wireless channel, and transmit a signal output from the controller 910 through the wireless channel.

The memory may store a program and data required for operations of the user equipment 900. Also, the memory may store control information or data included in a signal obtained by the user equipment 900. The memory may be a storage medium, such as read-only memory (ROM), random access memory (RAM), a hard disk, a CD-ROM, and a DVD, or a combination of storage media.

The controller 910 may control a series of controllers such that the user equipment 900 operates as described above. For example, the transceiver 920 may receive a data signal including a control signal transmitted by the base station or the network entity, and the controller 910 may determine a result of receiving the control signal and the data signal transmitted by the base station or the network entity.

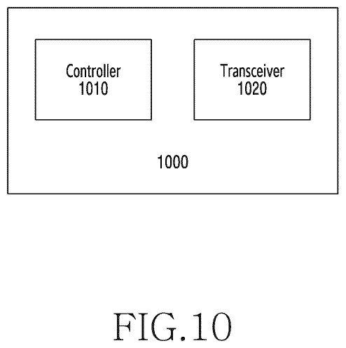

FIG. 10 illustrates a structure of a base station 1000 in accordance with various embodiments of the present disclosure. As shown in FIG. 10, the base station 1000 includes a controller 1010 and a transceiver 1020, where the controller 1010 is configured to perform the method performed by the base station that is disclosed herein above, and the transceiver 1020 is configured to transmit and receive a channel or a signal. Furthermore, the base station 1000 further includes a memory. Additionally, the components of the base station 1000 are not limited thereto. For example, the base station 1000 may include more or fewer components than those described above. In addition, the controller 1010 and the transceiver 1020 and the memory may be implemented as a single chip. Also, the controller 1010 may include at least one processor.

Furthermore, the base station 1000 may correspond to user equipment of FIG. 3B, the controller 1010 may correspond to a processor 378 of FIG. 3B, and the transceiver 1020 may correspond to the RF transceiver 372a-372n of FIG. 3B.

The transceiver 1020 collectively refers to a base station receiver and a base station transmitter, and may transmit/receive a signal to/from a user equipment or a network entity. The signal transmitted or received to or from the user equipment or a network entity may include control information and data. The transceiver 1020 may include a RF transmitter for up-converting and amplifying a frequency of a transmitted signal, and a RF receiver for amplifying low-noise and down-converting a frequency of a received signal. However, this is only an example of the transceiver 1020 and components of the transceiver 1020 are not limited to the RF transmitter and the RF receiver.

Also, the transceiver 1020 may receive and output, to the controller 1010, a signal through a wireless channel, and transmit a signal output from the controller 1010 through the wireless channel.

The memory may store a program and data required for operations of the base station. Also, the memory may store control information or data included in a signal obtained by the base station. The memory may be a storage medium, such as read-only memory (ROM), random access memory (RAM), a hard disk, a CD-ROM, and a DVD, or a combination of storage media.

The controller 1010 may control a series of processes such that the base station operates as described above. For example, the transceiver 1020 may receive a data signal including a control signal transmitted by the user equipment, and the controller 1010 may determine a result of receiving the control signal and the data signal transmitted by the user equipment.

Accordingly, the embodiment herein is to provide a method performed by a user equipment UE in a wireless communication network, comprising: receiving first information for scheduling a first frequency domain resource comprising a plurality of second frequency domain resources; upon receiving second information, determining, based on the first information and the second information and from the plurality of second frequency domain resources, a second frequency domain resource for downlink transmission or uplink transmission scheduled by the first information, and the second information comprising indication information indicating that each second frequency domain resource in the plurality of second frequency domain resources is a downlink frequency domain resource or an uplink frequency domain resource; and performing downlink transmission or uplink transmission on the determined second frequency domain resource.

In an embodiment, when the first information schedules downlink transmission, the downlink frequency domain resource indicated by the second information in the plurality of second frequency domain resources is used for the downlink transmission; or when the first information schedules uplink transmission, the uplink frequency domain resource indicated by the second information in the plurality of second frequency domain resources is used for the uplink transmission.

In an embodiment, when the first information schedules downlink transmission and a ratio of the downlink frequency domain resource indicated by the second information in the plurality of second frequency domain resources is greater than or equal to a first threshold, the downlink frequency domain resource indicated by the second information in the plurality of second frequency domain resources is used for the downlink transmission; or when the first information schedules uplink transmission, and a ratio of the uplink frequency domain resource indicated by the second information in the plurality of second frequency domain resources is greater than or equal to a second threshold, the uplink frequency domain resource indicated by the second information in the plurality of second frequency domain resources is used for the uplink transmission.

In an embodiment, when the first information schedules downlink transmission and the ratio of the downlink frequency domain resource indicated by the second information in the plurality of second frequency domain resources is less than the first threshold, the downlink transmission is not performed; or when the first information schedules uplink transmission and the ratio of the uplink frequency domain resource indicated by the second information in the plurality of second frequency domain resources is less than the second threshold, the uplink transmission is not performed.

In an embodiment, when the second information is not received, performing downlink transmission or uplink transmission on the plurality of second frequency domain resources scheduled by the first information.

In an embodiment, when the second information is received, performing downlink transmission or uplink transmission on the plurality of second frequency domain resources scheduled by the first information.

In an embodiment, wherein the first information is via dynamic scheduling, semi-persistent scheduling, or configured grant CG; and/or the second information is dynamic information or semi-static information.

In an embodiment, wherein the first frequency domain resource is a resource block group RBG, and the plurality of second frequency domain resources comprise physical resource blocks PRBs or resource blocks RBs.

Accordingly, the embodiment herein is to provide a method performed by a user equipment UE in a wireless communication network, comprising: receiving a first message comprising first information and second information, the first information used to schedule a first frequency domain resource comprising a plurality of second frequency domain resources, and the second information comprising indication information indicating that each second frequency domain resource in the plurality of second frequency domain resources being a downlink frequency domain resource or an uplink frequency domain resource; determining, based on the first information and the second information and from the plurality of second frequency domain resources, a second frequency domain resource for downlink transmission or uplink transmission scheduled by the first information; and performing downlink transmission or uplink transmission on the determined second frequency domain resource.

In an embodiment, wherein the first message is received via downlink control information DCI.

Accordingly, the embodiment herein is to provide a method performed by a base station in a wireless communication network, comprising: transmitting first information for scheduling a first frequency domain resource comprising a plurality of second frequency domain resources; performing downlink transmission or uplink transmission on at least one second frequency domain resource in the plurality of second frequency domain resources, wherein, when the second information is transmitted, the at least one second frequency domain resource is determined based on the first information and the second information, and the second information comprises indication information indicating that each of the plurality of second frequency domain resources is a downlink frequency domain resource or an uplink frequency domain resource.

In an embodiment, wherein the first information is via dynamic scheduling, semi-persistent scheduling, or configured grant CG; and/or the second information is dynamic information or semi-static information.

In an embodiment, wherein the first frequency domain resource is a resource block group RBG, and the plurality of second frequency domain resources comprise physical resource blocks PRBs or resource block RBs.

Accordingly, the embodiment herein is to provide a method performed by a base station in a wireless communication network, comprising: transmitting a first message comprising first information and second information, the first information used to schedule a first frequency domain resource comprising a plurality of second frequency domain resources, and the second information comprising indication information indicating that each second frequency domain resource in the plurality of second frequency domain resources being downlink frequency domain resource or uplink frequency domain resource; performing downlink transmission or uplink transmission on at least one second frequency domain resource in the plurality of second frequency domain resources, wherein, at least one second frequency domain resource is determined based on the first information and the second information.

In an embodiment, wherein the first message is transmitted via downlink control information DCI.

Accordingly, the embodiment herein is to provide a user equipment in a wireless communication network, comprising a transceiver and a controller coupled to the transceiver, wherein the controller is configured to perform the method of any one of claims 1 to 10.

Accordingly, the embodiment herein is to provide a base station in a wireless communication network, comprising a transceiver and a controller coupled to the transceiver, wherein the controller is configured to perform the method of any one of claims 11 to 15.

The various illustrative logic boxes, modules, and circuits described in the present disclosure may be embodied or executed by a general-purpose processor, a digital signal processor (DSP), an application-specific integrated circuit (ASIC), a field programmable gate array (FPGA) or another programmable logic device, a discrete gate or a transistor logic, a discrete hardware component, or any combination thereof designed to perform the functions described herein. A general-purpose processor may be a microprocessor, but in an alternative scenario, the processor may be any conventional processor, controller, microcontroller, or state machine. The processor may also be implemented as a combination of computing devices, such as a combination of a DSP and a microprocessor, a plurality of microprocessors, one or more microprocessors working with the DSP core, or any other such configurations.

The steps of the method or algorithm described in the present disclosure may be embodied directly in hardware, in a software module executed by the processor, or a combination thereof. The software module may reside in an RAM memory, a flash memory, an ROM memory, an EPROM memory, an EEPROM memory, a register, a hard disk, a removable disk, or any other forms of storage media known in the art. An exemplary storage medium is coupled to a processor so that the processor can read and write information from/to the storage medium. Alternatively, the storage medium may be integrated into the processor. The processor and storage medium may reside in an ASIC. The ASIC may reside in a user terminal. Alternatively, the processor and storage medium may reside in a user terminal as discrete components.

In one or more exemplary designs, the functions may be embodied in hardware, software, firmware, or any combination thereof. If implemented in software, the functions may be stored as one or more instructions or codes on a computer-readable medium or transmitted thereby. The computer-readable medium includes both a computer storage medium and a communication medium, and the latter includes any medium that facilitates the transfer of a computer program from one place to another place. The storage medium may be any available medium that can be accessed by a general-purpose or specialized computer.

By referring to the accompanying drawings, the descriptions set forth herein describe example configurations, methods, and apparatus, and do not represent all examples that are achievable or within the scope of the claims. As used herein, the term “example” means “used as an example, instance, or illustration,” instead of “preferred” or “superior to other examples.” The detailed description includes specific details and is intended to provide an understanding of the technologies described. However, these technologies may be practiced without these specific details. In some cases, well known structures and devices are shown in the block diagrams to avoid obscuring the concept of the examples described.

Although this specification contains a number of specific implementations, these should not be construed as a limitation of any disclosure or the patentable scope, but rather as a description of the specific characteristics of a particular embodiment of a particular disclosure. Some of the characteristics described in this specification in the context of individual embodiments may also be combined in a single embodiment. In contrast, the various characteristics described in the context of a single embodiment may also be implemented in multiple embodiments individually or in any suitable sub-combinations. In addition, although characteristics may be described above as acting in certain combinations and even being so originally claimed, in some cases, one or more characteristics from the combination for which protection is claimed may be removed from that combination, and the combination for which protection is claimed may be for a sub-combination or a variant of the sub-combination.

It should be understood that the particular sequence or hierarchy of steps in the method of present disclosure is an illustration of the exemplary process. Based on design preferences, it is understood that a particular sequence or hierarchy of steps in a method may be rearranged to achieve the functions and effects disclosed in the present disclosure. The attached method claims present the elements of the various steps in the example order and are not meant to be limited to particular order or arrangement as presented, unless otherwise specifically stated. In addition, although it is possible to describe or claim protection elements in the singular form, the plural form is also expected unless the restriction on the singular form is clearly stated. Accordingly, the present disclosure is not limited to the examples shown, and any apparatus used to perform the functions described herein is included in all aspects of the present disclosure. In addition, the symbol “/” used in the present application should be understood as “and/or.”

The text and drawings are provided as examples only to help readers understand this disclosure. They are not intended and should not be interpreted as limiting the scope of this disclosure in any way. Although certain embodiments and examples have been provided, based on the disclosure herein, it will be apparent to those skilled in the art that changes may be made to the illustrated embodiments and examples without departing from the scope of the present disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a user equipment (UE) in a wireless communication network, comprising:
receiving first information for scheduling a first frequency domain resource comprising a plurality of second frequency domain resources;
in response to receiving second information, determining, based on the first information, the second information, and the plurality of second frequency domain resources, a second frequency domain resource for a downlink transmission or an uplink transmission scheduled by the first information, wherein the second information comprises indication information indicating whether each of the plurality of second frequency domain resources is a downlink frequency domain resource or an uplink frequency domain resource; and
performing the downlink transmission or the uplink transmission based on the determined second frequency domain resource.

2. The method of claim 1, wherein:
when the first information schedules the downlink transmission, the downlink frequency domain resource indicated by the second information in the plurality of second frequency domain resources is used for the downlink transmission; or
when the first information schedules the uplink transmission, the uplink frequency domain resource indicated by the second information in the plurality of second frequency domain resources is used for the uplink transmission.

3. The method of claim 1, wherein:
when (i) the first information schedules the downlink transmission and (ii) a ratio of the downlink frequency domain resource indicated by the second information in the plurality of second frequency domain resources is greater than or equal to a first threshold, the downlink frequency domain resource indicated by the second information in the plurality of second frequency domain resources is used for the downlink transmission; or
when (i) the first information schedules the uplink transmission and (ii) a ratio of the uplink frequency domain resource indicated by the second information in the plurality of second frequency domain resources is greater than or equal to a second threshold, the uplink frequency domain resource indicated by the second information in the plurality of second frequency domain resources is used for the uplink transmission.

4. The method of claim 3, wherein:
when (i) the first information schedules the downlink transmission and (ii) the ratio of the downlink frequency domain resource indicated by the second information in the plurality of second frequency domain resources is less than the first threshold, the downlink transmission is not performed; or
when (i) the first information schedules uplink transmission and (ii) the ratio of the uplink frequency domain resource indicated by the second information in the plurality of second frequency domain resources is less than the second threshold, the uplink transmission is not performed.

5. The method of claim 1, further comprising:
when the second information is not received, performing the downlink transmission or the uplink transmission on the plurality of second frequency domain resources scheduled by the first information.

6. The method of claim 1, further comprising:
when the second information is received, performing the downlink transmission or the uplink transmission on the plurality of second frequency domain resources scheduled by the first information.

7. The method of claim 1, wherein the first information is identified via a dynamic scheduling, a semi-persistent scheduling, or a configured grant (CG); and
the second information comprises dynamic information or semi-static information.

8. The method of claim 1, wherein:
the first frequency domain resource comprises a resource block group (RBG), and
the plurality of second frequency domain resources comprises physical resource blocks (PRBs) or resource blocks (RBs).

9. A method performed by a base station in a wireless communication network, comprising:
transmitting first information for scheduling a first frequency domain resource comprising a plurality of second frequency domain resources; and
performing a downlink transmission or an uplink transmission on at least one second frequency domain resource in the plurality of second frequency domain resources,
wherein, when second information is transmitted, the at least one second frequency domain resource is determined based on the first information and the second information, and wherein the second information comprises indication information indicating whether each of the plurality of second frequency domain resources is a downlink frequency domain resource or an uplink frequency domain resource.

10. The method of claim 9, wherein:
the first information is identified via a dynamic scheduling, a semi-persistent scheduling, or a configured grant (CG); and
the second information comprises dynamic information or semi-static information.

11. The method of claim 9, wherein:
The first frequency domain resource comprises a resource block group (RBG); and
the plurality of second frequency domain resources comprises physical resource blocks (PRBs) or resource block (RBs).

12. A user equipment (UE) in a wireless communication network, the UE comprising:
a transceiver; and
at least one processor coupled to the transceiver and configured to:
receive first information for scheduling a first frequency domain resource comprising a plurality of second frequency domain resources,
in response to receiving second information, determine, based on the first information, the second information, and the plurality of second frequency domain resources, a second frequency domain resource for a downlink transmission or an uplink transmission scheduled by the first information, wherein the second information comprises indication information indicating whether each of the plurality of second frequency domain resources is a downlink frequency domain resource or an uplink frequency domain resource, and
perform the downlink transmission or the uplink transmission based on the determined second frequency domain resource.

13. The UE of claim 12, wherein:
when the first information schedules the downlink transmission, the downlink frequency domain resource indicated by the second information in the plurality of second frequency domain resources is used for the downlink transmission; or
when the first information schedules the uplink transmission, the uplink frequency domain resource indicated by the second information in the plurality of second frequency domain resources is used for the uplink transmission.

14. The UE of claim 12, wherein:
when (i) the first information schedules the downlink transmission and (ii) a ratio of the downlink frequency domain resource indicated by the second information in the plurality of second frequency domain resources is greater than or equal to a first threshold, the downlink frequency domain resource indicated by the second information in the plurality of second frequency domain resources is used for the downlink transmission; or
when (i) the first information schedules the uplink transmission and (ii) a ratio of the uplink frequency domain resource indicated by the second information in the plurality of second frequency domain resources is greater than or equal to a second threshold, the uplink frequency domain resource indicated by the second information in the plurality of second frequency domain resources is used for the uplink transmission.

15. The UE of claim 14, wherein:
When (i) the first information schedules the downlink transmission and (ii) the ratio of the downlink frequency domain resource indicated by the second information in the plurality of second frequency domain resources is less than the first threshold, the downlink transmission is not performed; or
when (i) the first information schedules uplink transmission and (ii) the ratio of the uplink frequency domain resource indicated by the second information in the plurality of second frequency domain resources is less than the second threshold, the uplink transmission is not performed.

16. The UE of claim 12, wherein the processor is further configured to, when the second information is not received, perform the downlink transmission or the uplink transmission on the plurality of second frequency domain resources scheduled by the first information.

17. The UE of claim 12, wherein the processor is further configured to, when the second information is received, perform the downlink transmission or the uplink transmission on the plurality of second frequency domain resources scheduled by the first information.

18. The UE of claim 12, wherein:
the first information is identified via a dynamic scheduling, a semi-persistent scheduling, or a configured grant (CG); and
the second information comprises dynamic information or semi-static information.

19. The UE of claim 12, wherein:
the first frequency domain resource comprises a resource block group (RBG); and
the plurality of second frequency domain resources comprises physical resource blocks (PRBs) or resource blocks (RBs).

20. A base station in a wireless communication network, the base station comprising:
a transceiver; and
at least one processor coupled to the transceiver and configured to:
transmit first information for scheduling a first frequency domain resource comprising a plurality of second frequency domain resources, and
perform a downlink transmission or an uplink transmission on at least one second frequency domain resource in the plurality of second frequency domain resources,
wherein, when second information is transmitted, the at least one second frequency domain resource is determined based on the first information and the second information, and wherein the second information comprises indication information indicating whether each of the plurality of second frequency domain resources is a downlink frequency domain resource or an uplink frequency domain resource.
